(19) United States
(12) Patent Application Publication
(10) Pub. No.: US 2025/0243694 A1
(43) Pub. Date: Jul. 31, 2025

(54) REPLACEMENT LOCK FOR STOREFRONT DOOR

(71) Applicant: Dezhao Xiang, Shenzhen (CN)

(72) Inventor: Dezhao Xiang, Shenzhen (CN)

(21) Appl. No.: 18/954,561

(22) Filed: Nov. 21, 2024

Related U.S. Application Data
(63) Continuation-in-part of application No. PCT/CN2024/131010, filed on Nov. 8, 2024.

(30) Foreign Application Priority Data
Jan. 29, 2024 (CN) 202410123874.X

(51) Int. Cl. E05B 63/08; E05B 63/00

(52) U.S. Cl. CPC E05B 63/08; E05B 63/0056; E05Y 2900/11

(57) ABSTRACT

A replacement lock for storefront door includes an outdoor component; an indoor component; a mortise, a spindle torque transmission component and one or more mounting components. The mortise includes a housing having one or more mounting holes; and a lock bolt movably receiving in the housing, the lock bolt is configured to extend out of the housing into the door frame to lock the storefront door, and retract from the door frame into the housing to unlock the storefront door upon driven. The spindle torque transmission component includes a spindle extending through the housing of the mortise and coupled with the lock bolt in a torque transmission way. The one or more mounting component extends through the one or more mounting holes of the housing of the mortise respectively, each mounting component has two axial ends that are respectively fixedly connected to the outdoor component and the indoor component.

### CROSS-REFERENCE TO RELATED APPLICATIONS

The present application is a Continuation in part Application of PCT Application No. PCT/CN2024/131010, filed on Nov. 8, 2024, which claims the priority of Chinese Patent Application No. 202410123874.X, filed on Jan. 29, 2024, the entire contents of which are hereby incorporated by reference.

### TECHNICAL FIELD

The present invention relates to the technical field of locks, and in particular to a replacement lock for storefront door.

### BACKGROUND

A lock refers to an apparatus that serves to close something, which includes a latch, indoor and outdoor components, lock cylinder, a key and accessories. With the development of science and technology, the market of replacement lock for storefront door (also called swing door) requires keyless locks or smart locks to solve the problem that the manager of the store has to give the key to the staff to lock the door, or go back to the store later to lock the store when it is very late, for example, in the midnight. The typical lock for storefront door cannot achieve the keyless lock or electrically lock or unlock by gear drive because the indoor and outdoor component are independently installed and operated which results in that the indoor and outdoor components are not connected to each other.

How to achieve connection of indoor and outdoor components of the replacement lock for storefront door with simple installation has become an urgent need in the art.

### SUMMARY

The objective of the present invention is to provide a replacement lock storefront door with simple installation and convenient operation.

A replacement lock for storefront door, configured to be installed in a storefront door so as to lock or unlock the storefront door relative to a door frame, the replacement lock includes:
an outdoor component, configured to mounted at an outer side of the storefront door;
an indoor component, configured to be mounted at an inner side of the storefront door;
a mortise including:
   a housing fixedly mounted in the storefront door, the housing having one or more mounting holes;
   a lock bolt movably received in the housing, wherein the lock bolt is configured to extend out of the housing into a bore of the door frame to lock the storefront door, and retract from the bore of the door frame into the housing to unlock the storefront door upon driven;
a spindle torque transmission component including a spindle having opposed first and second axial ends, the spindle extending through the housing of the mortise and coupled with the lock bolt in a torque transmission way; and
one or more mounting components, extending through the one or more mounting holes of the housing of the mortise respectively, the or each mounting component having two axial ends that are respectively fixedly connected to the outdoor component and the indoor component,
wherein the spindle is drivable and rotatable upon an action or a signal from the outdoor component or the indoor component, and upon directly or indirectly driven the spindle drives the lock bolt to extend out or retract back.

In some embodiments, the or each of mounting components includes a mounting screw with one end fixed to the indoor component, and the mounting screw has a threaded bolt passing through a corresponding mounting hole and being connected to the outdoor component in threaded connection.

In some embodiments, the or each of the mounting components further includes a threaded mounting post with one end fixed to the outdoor component, and an other end of the mounting post is screwed with the threaded bolt of a corresponding mounting screw.

In some embodiments, the replacement lock further includes a follower movably mounted in the housing of the mortise, wherein the spindle is coupled to the lock bolt through the follower, when the spindle rotates, the spindle drives the follower to rotate, and the follower in turn drives the lock bolt to extend out or retract back.

In some embodiments, the follower includes: a sleeve having a cam hole engageable with the spindle, and the spindle extending through the cam hole; and a drive protrusion extending from the sleeve to drive the lock bolt.

In some embodiments, the drive protrusion extends from an outer periphery of the sleeve.

In some embodiments, the drive protrusion drives the lock bolt through a torque transmission component.

In some embodiments, the torque transmission component comprises a lever, and one end of the lever is rotatable connected to the lock bolt, and wherein the drive protrusion and the lever are rotatable connected to each other through a pin and a groove that are engaged with each other.

In some embodiments, the pin is provided on the level, and the groove is formed in the drive protrusion.

In some embodiments, the pin is formed on the drive protrusion, and the groove is formed in the level.

In some embodiments, the groove is elongated with a length measured in an axial direction of the lever greater than a width measured in a lateral direction of the lever perpendicular to the axial direction.

In some embodiments, the torque transmission component comprises a slide block, the lock bolt is provided with a receiving groove in which the slide block is slidable received, and a distal end of the drive protrusion abuts against an upper surface of the slide block.

In some embodiments, the upper surface of the slide block is a convex curved surface.

In some embodiments, the replacement lock further includes an elastic component provided in the receiving groove, and the elastic component abuts against a bottom of the slide block to bias the slide block upwardly.

In some embodiments, an upper end of the receiving groove is flared and a surface surrounding the upper end of the receiving groove is inclined.

In some embodiments, the torque transmission component comprises a torque transmission plate, one end of the torque transmission component is rotatably connected to the lock bolt, and an other end of the torque transmission component is provided with a groove into which a distal end of the drive protrusion of the follower extends.

In some embodiments, the groove is U shaped, and the torque transmission plate has a peg at an opening end of the groove.

In some embodiments, the outdoor component comprises a lock cylinder and an external force drive element both connected to the spindle; or the outdoor component is coupled to an actuator connected to the spindle.

In some embodiments, the indoor component comprises an external force drive element or is coupled to an actuator connected to the spindle.

In some embodiments, the replacement lock further includes a blocking member fixed in the housing, wherein the housing of the mortise has a lateral opening through which the lock bolt extends out of the housing and retracts back into the housing, and the blocking member is arranged to block a path in the housing from the lateral opening to the follower.

### BRIEF DESCRIPTION OF DRAWINGS

In order to illustrate the embodiment of the disclosure more clearly, the following is a brief description of the drawings used in the embodiment. Apparently, the drawings described below are only some embodiments of the disclosure, and other drawings can be obtained according to these drawings for the person skilled in the art without creative labor.

FIG. 1 is a schematic installation view of a replacement lock for storefront door according to a first embodiment of the present disclosure.

FIG. 2 is an exploded view of the replacement lock for storefront door shown in FIG. 1.

FIG. 3 is an exploded view of the replacement lock for storefront door shown in FIG. 2 from another aspect.

FIG. 4 is a perspective view of a follower in the replacement lock for storefront door shown in FIG. 2.

FIG. 5 is an installation view of the mortise in the replacement lock for storefront door shown in FIG. 1.

FIG. 5a shows an alternative follower and corresponding lever.

FIG. 6 is a sectional view of the replacement lock for storefront door according to the first embodiment of the present disclosure.

FIG. 7 is a schematic installation view of the replacement lock for storefront door according to a second embodiment of the present disclosure.

FIG. 8 is a schematic installation view of the mortise in the replacement lock for storefront door according to the second embodiment of the present disclosure.

FIG. 9 is a schematic installation view of the replacement lock for storefront door according to a third embodiment of the present disclosure.

FIG. 10 is a schematic installation view of the mortise in the replacement lock for storefront door shown in FIG. 9.

FIG. 11 is a schematic installation view of replacement lock for storefront door according to a fourth embodiment of the present disclosure.

FIG. 12 shows the interior of the mortise shown in FIG. 11, in which a first shell is removed.

FIG. 13 is a schematic installation view of a replacement lock for storefront door according to a fifth embodiment of the present disclosure.

FIG. 14 shows the interior of the mortise of the replacement lock for storefront door shown in FIG. 13, in which a first shell is removed.

FIG. 15 shows the detail structure of the follower of the replacement lock for storefront door shown in FIG. 14.

FIG. 16 is a schematic view of a replacement lock for storefront door according to a sixth embodiment of the present disclosure, in which the outdoor component and the indoor component are removed for clarity.

FIG. 17 shows the replacement lock of FIG. 16, in which the second shell is removed to show the interior of the housing of the mortise.

FIG. 18 shows the replacement lock of FIG. 17, in which the blocking member is further removed to show the installation hole.

FIG. 19 shows the blocking member of the replacement lock shown in FIG. 16.

FIG. 20 is a schematic view illustrating a storefront door equipped with the replacement lock of the present disclosure.

FIG. 21 is a schematic diagram illustrating a replacement lock for storefront door according to another embodiment of the present disclosure.

### DESCRIPTION OF EMBODIMENTS

In order to make the purpose, technical solution and advantages of the disclosure more clearly, the disclosure is further explained in detail in combination with the following accompanying drawings and embodiments. It should be understood that the specific embodiments described herein are only used to explain the disclosure and are not used to limit the disclosure.

It should be noted that the terms “arranged” and “connection” should be understood in a broad sense, for example, they may be arranged and connected directly, or indirectly through intermediate elements or intermediate structures.

In addition, if the terms indicating orientation or position relationship such as “vertical”, “horizontal”, “length”, “width”, “thickness”, “up”, “down”, “front”, “rear”, “left”, “right” and “vertical”, “level”, “top”, “bottom” “within” and “outside” are present in the context, it is based on the orientation or position relationship shown in the accompanying drawings or the normal placement in use, and is only intended to facilitate the descriptions of the disclosure, but not to indicate or imply that the structure, feature, device or element referred to must have a specific orientation or position relationship, neither must it be constructed and operated in a specific orientation, and therefore it cannot be construed as a limitation of the disclosure. In the description of the disclosure, the term “a plurality of” is two or more.

The various specific technical features and embodiments described in the specific embodiments may be combined in any suitable manner, provided that there is no conflict, for example, different embodiments may be formed by combining different specific technical features or embodiments. in order to avoid repetition, the various possible combinations of the specific features or embodiments of the present invention are not described in detail.

### First Embodiment

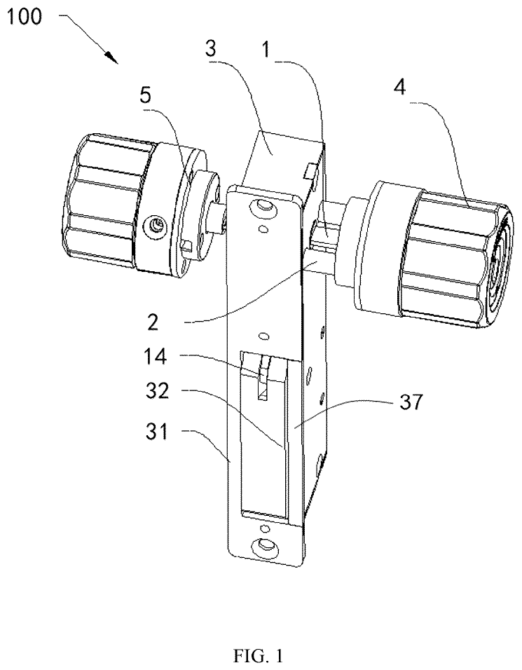

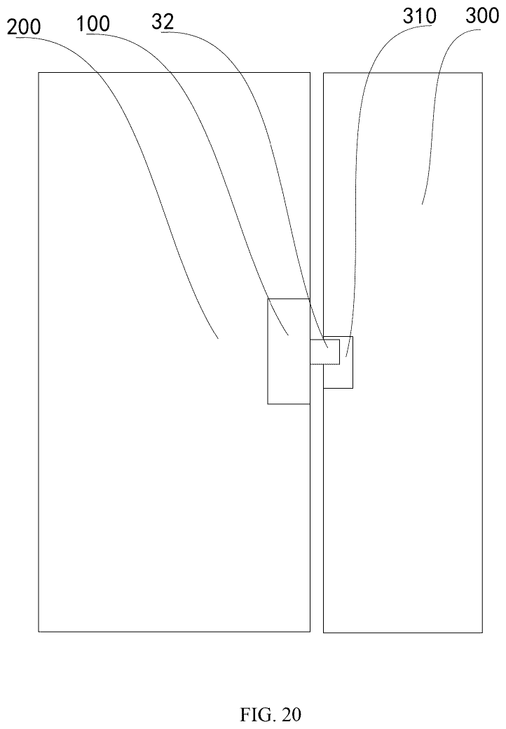

The disclosure provides a replacement lock for storefront door, please refer to FIG. 1 to FIG. 6, a replacement lock according to a first embodiment of the present disclosure is shown. The replacement lock 100 can be installed on a storefront door 200 and is used to releasably lock the storefront door 200 with respect to a door frame 300 (see FIG. 20). The replacement lock 100 includes an outdoor component 4, an indoor component 5, a mortise 3, a spindle torque transmission component 1 and a mounting component 2.

The outdoor component 4 is installed on the outside of the storefront door 200. The indoor component 5 is installed on the inside of storefront door 200. The outside and inside are opposite sides of the storefront door 200. Specifically, the storefront door has an inner surface and an outer surface opposite to each other with a cavity formed there between for accommodating the mortise 3. Generally, when the storefront door 200 is used, the inner side/surface of the storefront door 200 facing the interior is the inside, and the outer side/surface of the storefront door 200 facing the outside is the outside. The indoor component 5 is mounted at the inner surface and the outdoor component 4 is mounted at the outer surface.

The mortise 3 includes a housing 31 fixed in the storefront door 200, and a lock bolt 32 movably arranged in the housing 31. The housing has an axial through hole and a lateral opening 37. When driven, the lock bolt 32 can extend out from the housing 31 via the lateral opening 37 into the door frame 300 or retracted from the door frame 300 into the housing 31 to lock or unlock the storefront door 200 relative to the door frame 300. The housing 31 is provided with one or more mounting holes 13 penetrating there through in a direction from the indoor component 5 to the outdoor component 4.

The spindle drive assembly 1 includes a spindle 11 extending through the housing 31 of the mortise 3, and a follower 12 arranged within the housing 31 of the mortise 3.

The follower 12 is in torque-transmission connection with the lock bolt 32. The spindle 11 extends through the housing 31 via the axial through hole of the housing 31 with two axial ends extending out of two opposite sides of the housing 31. Accordingly, a middle portion of the spindle 11 is located in the housing 31 of the mortise 3, and the middle portion of the spindle 11 is detachably connected to the follower 12 in a torque transmission manner. One axial end of the spindle 11 is drivable upon an action of the outdoor component 4, and the other axial end of the spindle 11 is drivable upon an action of the indoor component 5. When driven directly or indirectly by the outdoor component 4 or the indoor component 5, for example upon an action of the outdoor component 4 or an action of the indoor component 5, the spindle 11 can rotate in a first direction and drives the follower 12 to move, which in turn drives the lock bolt 32 to extend out of the housing 31 of the mortise 3 into the door frame 300 to lock the storefront door 200; and the spindle 11 can also rotate in a second direction and drives the follower 12 to move, which in turn drives the lock bolt 32 to retract back into the housing 31 from the door frame 300 to unlock the storefront door 200.

Specifically, the lock bolt 32 can be engaged in a lock groove 310 of the door frame 300 when extended out, so as to achieve the locking of the storefront door 200. The lock bolt 32 can be disengaged from the lock groove 310 of the door frame 300 when retracted back, so as to achieve the unlocking of the storefront door 200.

The first direction is opposite to the second direction, specifically, one of the directions is clockwise, and the other direction is counterclockwise.

Specifically, the action of the outdoor component 4 and/or the indoor component 5 may be caused by a key, or an external force applied thereon.

In some embodiments, the outdoor component 4 may include a lock cylinder 41 with which a key may be engageable, and the lock cylinder 41 is connected to the spindle 11. In that case, the action may be caused by a key.

In some embodiments, the outdoor component 4 may include an external force drive element 43 which is connected to the spindle 11, and the action may be caused by an external force exerted on the external force drive element 43.

In some embodiments, the indoor component 5 may also include an external force drive element 52 which is connected to the spindle 11, and the action may be caused by an external force exerted on the external force drive element 52.

In some embodiments, the indoor component 5 may also include a lock cylinder with which a key may be engageable, and the lock cylinder is connected to the spindle. In that case, the action may be caused by a key.

It should be noted that, the replacement lock may be a magnetic lock, a smart card door lock, or a fingerprint lock, in which the outdoor component 4 or the indoor component 5 is coupled to an actuator instead of a lock cylinder.

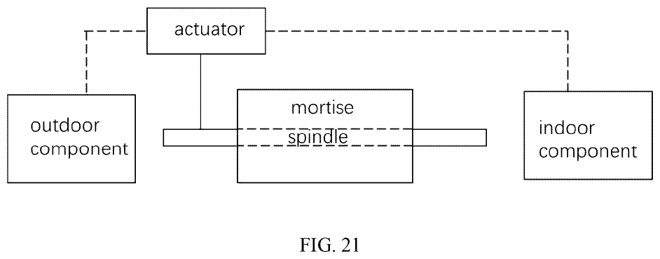

In this case, for example, referring to FIG. 21, the spindle extends through the mortise 3 and coupled with the follower 12 arranged in the mortise 3, with two axial ends of the spindle 11 extend outside of the mortise 3.

One axial end of the spindle may be connected or coupled to an actuator which can drive the spindle 11 to rotate in response of a signal of the outdoor component 4 or the indoor component 5. The signal may be caused by a contact of a smart card, a fingerprint identification etc. The actuator may be an electrical actuator or a magnetic actuator.

According to the present embodiment shown in FIGS. 1 to 3, one end of the spindle 11 is directly driven by the outdoor component 4 through the lock cylinder 41 or the external force drive element 43. The other end of the spindle 11 may be directly driven by the indoor component 5 through a lock cylinder or the external force drive element 52.

Alternatively, as discussed above, according to the embodiment shown in FIG. 21, one end of the spindle 11 may be driven by an actuator which works in response to a signal of the outdoor component 4 or the indoor component.

The mounting component 2 includes a fastening component 20. A middle section of the fastening component 20 passes through the mounting hole 13 on the housing 31 of the mortise 3, and the two ends of the fastening component 20 are mounted and fixed to the outdoor assembly 4 and the indoor assembly 5, respectively.

During installation, the mortise 3 can be fixed in the storefront door 200 first, and then the spindle 11 extends through the housing 31 of the mortise 3 from the lock cylinder 41 of the outdoor component 4 and is connected to the indoor component 5, with the spindle 11 being torque-transmission connected with the follower 12. At the same time, the middle section of the fastening component 20 passes through the mounting hole 13 on the housing 31 of the mortise 3, and the two ends of the fastening component are respectively fixed and connected with the outdoor component 4 and the indoor component 5, so that the outdoor component 4, the indoor component 5 and the mortise 3 can be connected one another in the axial direction and fixed on the storefront door 200 by the mounting component 2, and thus achieving the installation of the replacement lock for storefront door 100.

When in use, the spindle 11 can rotate in the first direction in response to an action or a signal of the outdoor component 4 or the indoor component 5, and the spindle 11 drives the follower 12 to move and drive the lock bolt 32 to extend out so as to lock the storefront door 200 relative to the door frame 300 (see FIG. 20). The spindle 11 can also rotate in the second direction to drive the follower 12 to move and drive the lock bolt 32 to retract back so as to unlock the storefront door 200 relative to the door frame 300.

Therefore, the lock according to the present invention can not only facilitate the installation and fixing of the indoor and outdoor components on both sides of the mortise 3 aligned with the spindle 11, but also reduce the installation difficulty and solve the problem in installing a replacement lock 100 for a storefront door. Moreover, it can realize the connection between indoor and outdoor components and the mortise 3, facilitating the coordination between indoor components 5 and outdoor components 4, and make it possible to lock and unlock with keyless lock or electronic lock with gear drive.

It can be understood that in this embodiment, the replacement lock for storefront door 100 is preferably used on the storefront door 200, so as to facilitate the unlocking and locking of the storefront door 200 relative to the door frame 300. In one embodiment of the present invention, the replacement lock for storefront door 100 can be used for a double door, that is, the replacement lock for storefront door 100 is arranged on one storefront door 200, and the door frame 300 is another storefront door (for example, door lock for double door is commonly used by KFC and other stores).

It is understood that the replacement lock for storefront door 100 can be used to replace the previous lock of the shop door. After removing the previous lock, there is no need to modify the original mounting hole or drill one or more new hole in the storefront door 200, and the installation can be achieved by just using the original or previously presented installation hole.

Preferably, in this embodiment, referring to FIGS. 1 to 6, the fastening component 20 may include a mounting screw 22 arranged on the indoor component 5, and the mounting screw 22 may have a threaded bolt 221 to be connected with the outdoor component 4 in threaded connection to achieve the installation and alignment of the indoor component 5 and the outdoor component 4.

As a possible first implementation of the fastening component 20 in the present invention, the fastening component 20 may further include a mounting post 21 with one end fixed on the outdoor component 4, and the other end threaded to the mounting screw 22. The connected mounting post 21 and the mounting screw 22 passes through the mounting hole 13 on the housing 31 of the mortise 3. The mounting post 21 is provided with an internal screw thread which is engageable with the outer screw thread of the mounting screw 22, which brings a more robust installation and avoiding damage of the outdoor component 4 when the mounting screw 22 is directly mounted on the outdoor component 4. In this embodiment, a distal end of the mounting post 21 passes through the mounting hole 13 of the mortise 3 and is engaged with the mounting screw 22.

As a possible second embodiment of the fastening component 20 according to the disclosure, the mounting screw 22 on the indoor component 5 passes through the mounting hole 13 of the housing 31 of the mortise 3 and is screw in a screw hole 211 of the outdoor component 4, to thereby connect the outdoor component 4, the indoor component 5 and mortise 3 with the storefront door 200. It is understood that, in other embodiments, mounting post 21 may be provided on the outdoor component 4, and the mounting screw 22 may be connected to mounting post 21 after extending through the housing 31 of the mortise 3 to avoid damage of the outdoor component 4 when the mounting screw 22 is directly mounted on the outdoor component 4.

It should be understood that the position of the mounting post and the position of the mounting screw may be exchanged, that is, the mounting post is provided on the indoor component and the mounting screw is provided on the outdoor component.

It is understood that mounting screws 22 and mounting posts 21 are equal in number. In some embodiments, there is only one mounting screw 22 and one mounting post 21, and accordingly there is only one mounting hole 13 on the housing 31 of the mortise 3, thus it is appropriate for a storefront door with only one installation hole which is originally or previously formed. Alternatively, in some embodiments, a plurality of mounting screws 22 and a plurality of mounting posts 21 with equal number are provided. A plurality of mounting holes 13 are provided in the housing 31 of the mortise 3, the number of the mounting holes 13 is equal to the number of the mounting screws 22 and the number of the mounting posts 21. The mounting holes 13 are respectively aligned with the mounting screws 22 and the mounting posts 21 in the axial direction of the spindle 11, which can not only facilitate the alignment of the outdoor component 4 and the indoor component 5, but also make the connection between outdoor component 4 and indoor component 5 more stable.

Referring to FIG. 1 through FIG. 6, preferably, the mortise 3 can be provided with a receiving space for accommodating the follower 12 and the lock bolt 32, so as to effectively protect the follower 12 and the lock bolt 32 and improve the service life of the lock.

In the present embodiment, the housing 31 of the mortise 3 includes a first shell 311 and a second shell 312 connected together. The first shell 311 and the second shell 312 cooperatively define the receiving space, and the mounting hole 13 penetrates through the first shell 311 and the second shell 312, forming a first side mounting hole 13a on the first shell 311 and a second side mounting hole 13b on the second shell 312 for allowing the fastening component 20 to pass through.

Referring to FIGS. 1 to 6, the follower 12 is detachably mounted in the mortise 3. The spindle 11 may extend through the follower 12 with two axial ends thereof respectively connected to the outdoor component 4 and indoor component 5. Alternatively, as described above, the spindle 11 may not be directly connected to the outdoor component 4 and/or the indoor component 5, but connected to one or more drive assemblies that can be activated in response to an action or a signal of the outdoor component 4 and/or the indoor component 5.

Preferably, the follower 12 may directly drive the bolt 32 to extend out or retract back. Alternatively, the follower 12 may indirectly drive the bolt 32 to extend out or retract back through a torque transmission component 14.

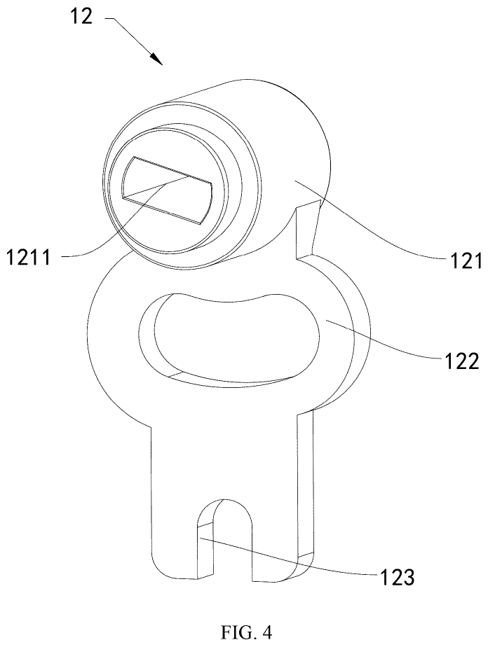

It is understood that the spindle 11 is torque-transmission connected to the follower 12. Preferably, as shown in FIG. 4, the follower 12 may include a sleeve 121 and a drive protrusion 122 connected to the sleeve 121. The sleeve 121 is provided with an cam hole 1211 engageable with the spindle 11. The spindle 11 passes through the cam hole 1211, and the sleeve 121 is rotatable with the rotation of the spindle 11. The drive protrusion is used to drive the lock bolt 32 with the rotation of the sleeve 121. Further, the drive protrusion 122 may be connected to or extend outwardly from the outer periphery of the sleeve 121, so that the drive protrusion can directly or indirectly drive the lock bolt 32 to extend out or retract back.

Alternatively, the drive protrusion may also be extended radially outwardly from the end surface of the sleeve 121 beyond the outer periphery of the sleeve 121, which can also achieve the rotation of the drive protrusion 122 together with the rotation of the sleeve 121, to thereby drive and move the lock bolt 32.

Preferably, the cross section of the cam hole 1211 is in form fit with the cross section of the spindle 11. The disclosure does not intend to limit the shapes of the cross section of the cam hole 1211 and the cross section of the spindle 11. For example, the cross sections of the cam hole 1211 and the spindle 11 can be rectangular or square. Another example is that the cross sections of the cam hole 1211 and the spindle 11 may be in the shape of a cross. It can be understood that the cam hole 1211 and the spindle 11 may not be in form fit, provided that the inner wall of the sleeve 121 has a limiting structure for limiting the rotation of the spindle 11 in the clockwise and counterclockwise directions, torque-transmission connection between the spindle 11 and the sleeve 121, i.e., the drive protrusion, can also be achieved.

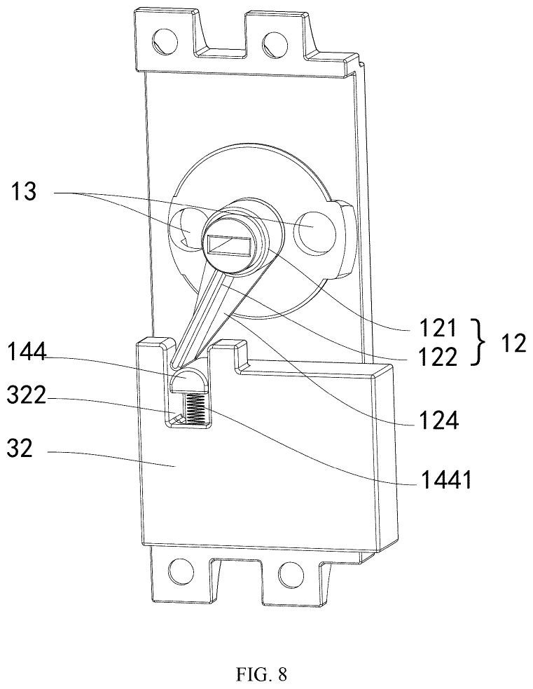

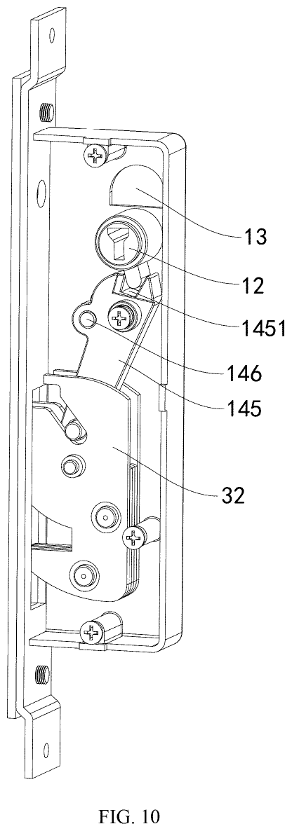

Referring to FIG. 4, the drive protrusion can be a plate (see FIG. 4), a sheet (see FIG. 8), a strip or a block (see FIG. 10), etc., as long as it can directly or indirectly drive the lock bolt 32 to extend out or retract back.

Referring to FIG. 1 through FIG. 6, in some embodiments, the drive protrusion 12 may indirectly drive the lock bolt 32 to extend out or retract back through torque transmission component 14.

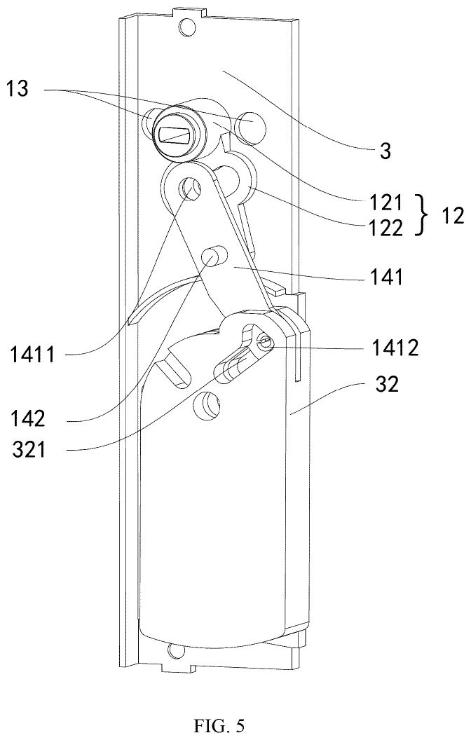

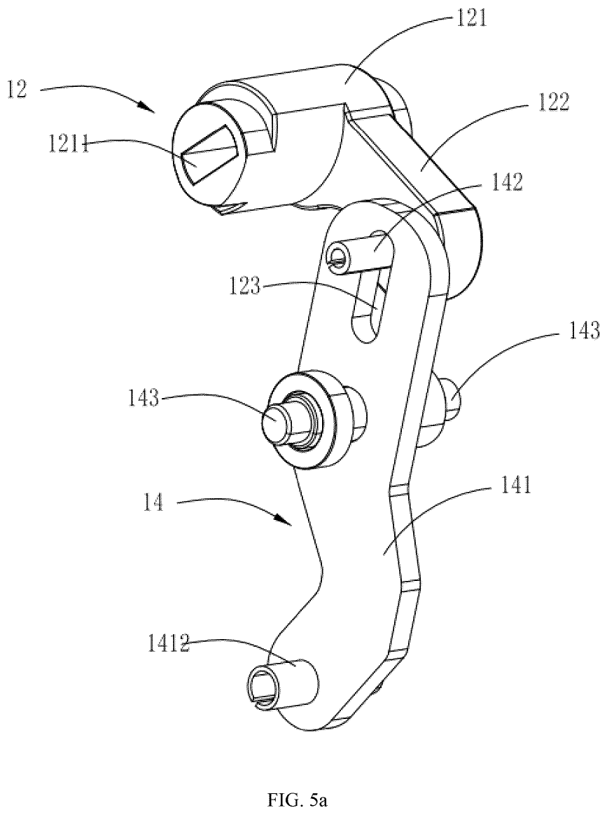

Specifically, see FIG. 5, the torque transmission component 14 may include a lever 141, the upper end of the lever 141, i.e., the end adjacent to the follower 12, is pivotally connected, for example hinged to the mortise 3. The lower end of the lever 141, i.e., the end away from the end of the follower 12, is rotatably connected to the lock bolt 32. The middle portion of the lever 141, i.e., the portion between the upper and lower end of the lever 141 is rotatably connected to the follower 12 by a pin 142.

When the follower 12 rotates in the first direction, the drive lever 141 drives the lock bolt 32 to extend out and be engaged with the door frame 300 to lock the storefront door 200; when the follower 12 rotates in the second direction, the lower end thereof the drive lever 141 moves in the second direction, the drive lever 141 drives the lock bolt 32 to retract back and unlock the storefront door 200.

In other embodiments, it may be the middle portion of the lever 141 that is pivotally connected to the mortise 3. Accordingly, the upper end of the lever 141 is rotatably connected with the follower 12, and the lower end of the lever 141 is rotatably connected to the lock bolt 32. In that case, when the follower 12 rotates in the first direction, it drives the lock bolt 32 retract back and the storefront door 200 is unlocked; when the follower 12 rotates in the second direction, it drives the lock bolt 32 to extend out and engage with the door frame 300.

In this embodiment, the pin 142 is fixed on the lever 141, the follower 12 is provided with a groove 123, the pin 142 is engaged in the groove 123 and can abut against the wall of the groove 123. When the follower 12 rotates, the wall of the groove 123 acts on the pin 142, thus achieving the rotatable connection between the follower 12 and the lever 141, which enable the lever 141 to move.

In particular, the groove 123 has a length greater than its width, and the width of the groove 123 is substantially equal to or slightly larger than the diameter of the pin 142, such that the pin 142 is slidably engaged in the groove 123, thereby achieving rotatable connection between the follower 12 and the lever 141 by the engagement of the pin 142 and the groove 123 while allowing displacement therebetween in the lengthwise or longitudinal direction of the groove 123.

In this embodiment, the groove 123 is open at one longitudinal end.

Referring to FIG. 5, the lower end of the lever 141 adjacent to the lock bolt 32 may be provided with a sliding shaft 1412. One end of the lock bolt 32 is rotatably connected to the mortise 3, and is provided with a sliding groove 321 engageable with the sliding shaft 1412. The sliding shaft 1412 is slidably engaged in the sliding groove 321. When the follower 12 rotates, the lever 141 drives lock bolt 32 to rotate and the other end of the lock bolt 32 moves to extend out or retract back. In the meanwhile, the sliding shaft 1412 of the lever 141 slides in the sliding groove 321. The wall of the sliding groove 321 limits a position of the sliding shaft 1412, and thus limit the displacement of the sliding shaft 1412, avoiding deviation of the rotation of the lever 141 or the lock bolt 32 and interference with other components.

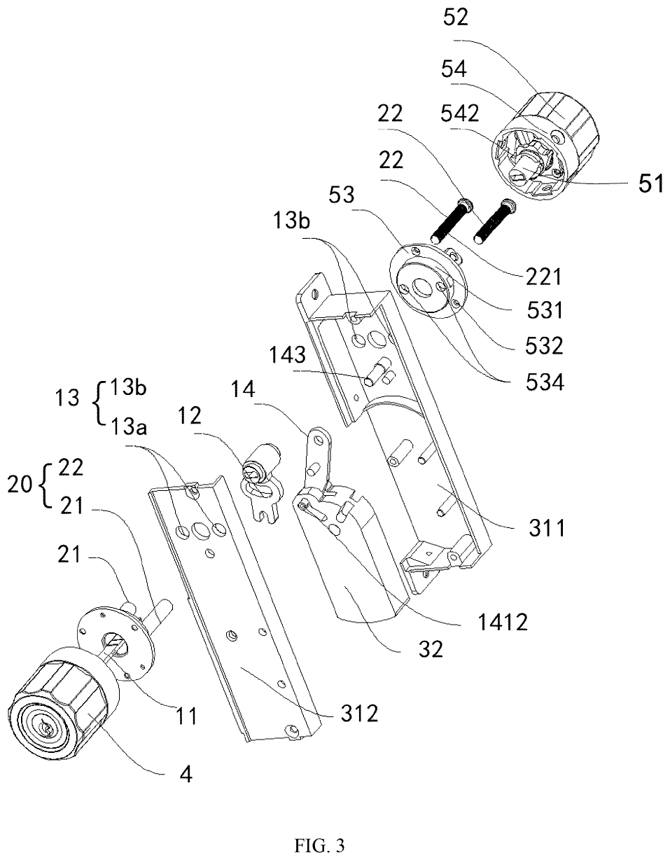

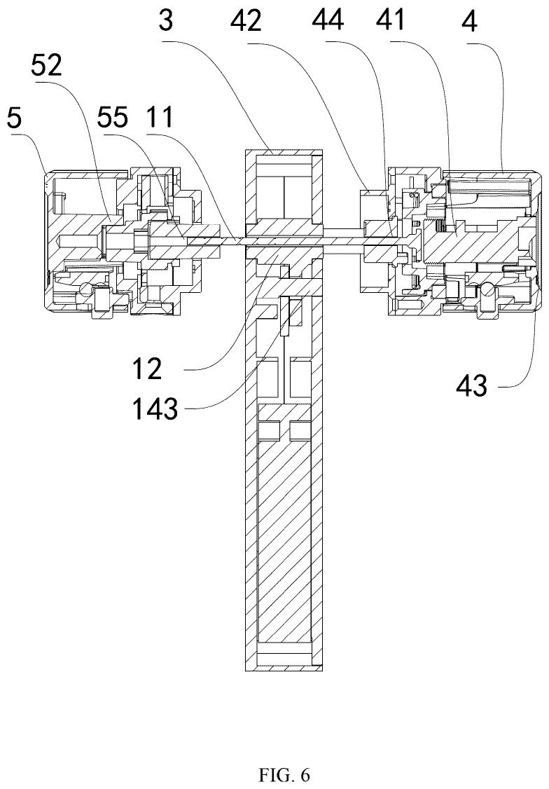

Specifically, please refer to FIG. 3, FIG. 5 and FIG. 6. The torque transmission component 14 may further include a pivot shaft 143 fixed in mortise 3, one end of lever 141 is provided with a cam hole 1411 engageable with the pivot shaft 143, and the pivot shaft 143 is rotatably inserted into the cam hole 1411, so that one end of lever 141 is rotatably connected to the mortise 3.

It should be understood that the specific way of rotatable connection between the follower 12 and the lever 141 is not limited to this particular embodiment, it just requires that rotatable connection between the follower 12 and the lever 141.

Alternatively, the locations of the pin and the groove can be exchanged. For example, referring to FIG. 5a, the pin 142 is fixed on the drive protrusion 122 of the follower 12, and the corresponding groove 123 is provided at the upper end of the lever 141. The pin 142 is inserted in the groove 123 to achieve the rotatable connection between the follower 12 and the lever 141. In this embodiment shown in FIG. 5a, the groove 123 also has a length greater than the diameter of the pin which also achieves rotatable connection between the follower 12 and the lever 141 by the engagement of the pin 142 and the groove 123 while allowing displacement therebetween in the lengthwise or longitudinal direction of the groove 123.

This embodiment differs from the above embodiment in that, the groove 123 is closed circumferentially without any open end. Further, in this embodiment, the groove 123 is provided at the upper end of the lever 141, and the middle portion of the lever 141 is rotatably connected to the mortise 3 through pivot shafts 143.

The lock bolt 32 can be rectangular (see FIG. 5) or has a hook (see FIG. 10), etc., as long as it can be matched with the lock groove 310 of the door frame 300. It is understood that when the lock bolt 32 has a hook, a protrusion or a slot may be provided at a wall facing the lock groove 310 to engage with the hook of the lock bolt 32, thus achieving more stable locking of the storefront door 200 relative to the door frame 300.

In the above, the follower 12 drives the lock bolt 32 to extend out or retract back to achieve the locking or unlocking of the storefront door 200 by means of the lever 14. Alternatively, the follower 12 may drive the lock bolt 32 to extend out or retract back by means of a gear assembly. For example, the follower 12 may be provided with a first gear, and a second gear meshed with the first gear is provided in the mortise 3 and serves as the torque transmission component 14. The second gear is connected with the lock bolt, and the rotation of the second gear drives the lock bolt to extend out and retract back.

Referring to FIG. 1 to FIG. 6. The lock cylinder 41 of the outdoor component 4 may be a lock cylinder of a pin tumbler lock, a flat tumbler lock. Alternatively, the lock cylinder 41 may be omitted in case that the outdoor component 4 is based on a magnetic lock, a smart card door lock, or a fingerprint lock, etc. The disclosure does not limit the specific lock cylinder 19 structure of outdoor component 4.

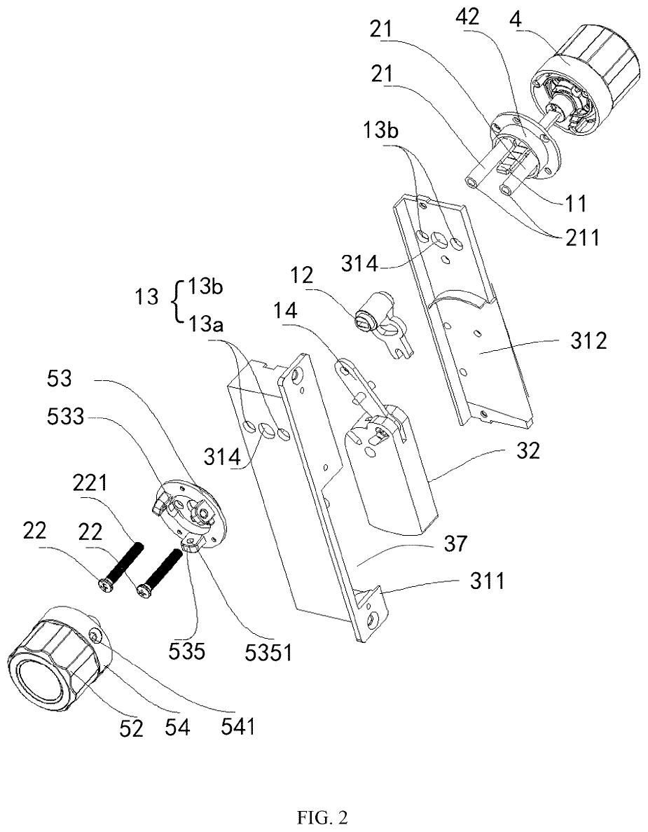

Preferably, please refer to FIG. 2 and FIG. 6, the outdoor component 4 may be provided with an abutment wall 42 extending towards the mortise 3. During installation, the abutment wall 42 is engaged in a recess of the storefront door, to on the one hand stably positioning the outdoor component 4 and on the other hand prevent lockpicking. Further, the abutment wall 42 may surround the mounting posts 21, thereby protecting the mounting posts 21. In this embodiment, the abutment wall 42 is an annular wall.

Preferably, the outdoor component 4 may further include a first external force drive element 43 connected with the lock cylinder 41 of the outdoor component 4 or the spindle 11. The first external force drive element 43 is used to drive the lock cylinder 41 of the outdoor component 4 or the spindle 11, thereby driving the spindle 11 to rotate in the first direction or the second direction, so that the follower 12 drives the lock bolt 32 to extend out or retract back. Specifically, the first external force drive element 43 may be a knob, a handle mounted around the lock cylinder of the outdoor component 4 or a motor.

When the user locks the storefront door 200 by the outdoor component 4, which can be achieved by a first torque in the first direction acting on the first external force drive element 43, or by a key, a fingerprint or an electronic password, etc., the spindle 11 drives the follower 12 to rotate in the first direction under the action of the first torque along the first direction. The lock bolt 32 extends out from the mortise 3 and is engaged in the lock groove 310 of the door frame 300, so as to realize the lock of the storefront door 200.

When the user unlock the storefront door 200 by the outdoor component 4, for example, by a key, a fingerprint or an electronic password, etc., the spindle 11 rotates in the second direction under the action of the second torque (along the second direction), which drives the follower 12 to rotate in the second direction, and the lock bolt 32 is retracted into the mortise 3 and disengaged from the lock groove 310 of the door frame300, so as to realize the unlocking of the storefront door 200.

Referring to FIGS. 1 to 6. In this embodiment, the indoor component 5 is not equipped with a lock cylinder, and the spindle 11 on the outdoor component 4 is directly coupled to indoor component 5 by a detachable coupling structure after passing through the follower 12 in the mortise 3.

Preferably, the indoor component 5 may include a cylindrical element 51, and the spindle 11 is directly and detachably fixed with the cylindrical element 51 of the indoor component 5 after passing through the housing 31 of the mortise 3 and coupled with the follower 12, thereby driving the spindle 11 to rotate, and thus assembly and disassembly are both convenient.

In other embodiments, indoor component 5 may also be provided with a lock cylinder that is connected to the spindle 11 instead of a cylindrical element. The lock cylinder of indoor component 5 may be cylinder of a pin tumbler lock, a flat tumbler lock. Alternatively, the lock cylinder 41 may be omitted in case that the outdoor component 4 is based on a magnetic lock, a smart card door lock, or a fingerprint lock, etc. The disclosure does not limit the specific type of the lock cylinder of the indoor component 5, as long as it can meet the use requirements of the lock.

It can be understood that because the spindle 11 is coupled to the outdoor component 4 and the indoor component 5, the outdoor component 4 and the indoor component 5 can cooperate with each other. The outdoor component 4 and the indoor component 5 may have different kinds of lock cylinders. For example, the outdoor component 4 is a commonly used mechanical lock structure, and the indoor component 5 may be an electronic lock such as an electronic password lock or an electronic fingerprint lock, so that it is more convenient to lock and unlock the storefront door 200through the indoor component 5, and the keyless lock or electronic lock and unlock by a gear drive is realized, which well meets the requirements of replacing lock for storefront doors.

Preferably, the indoor component 5 may further include a second external force drive element 52 connected with the lock cylinder of the indoor component 5 or the spindle 11. The second external force drive element 52 is configured to drive the lock cylinder or the spindle 11, thereby driving the spindle 11 to rotate in the first direction or the second direction, so that the follower 12 drives the lock bolt 32 to extend out or retract back. Specifically, the second external force drive element 52 may be a knob or a handle mounted around the lock cylinder of the indoor component or a motor.

When the user locks the storefront door 200 by the indoor component, the second external force drive element 52 rotates in the first direction under the action of the first torque in the first direction, which drives the spindle 11 to rotate in the first direction, and then drives the follower 12 to rotate in the first direction, and in turn the lock bolt 32 extends out from the mortise 3 and is engaged with the lock groove 310 of the door frame 300, so as to realize the locking of the door frame 300.

When the user unlock the storefront door 200by the indoor component 5, the second external force drive element 52 rotates in the second direction under the action of the second torque along the second direction, which drives the spindle 11 to rotate in the second direction, and then drives the follower 12 to rotate in the second direction, and the lock bolt 32 retracts into the mortise 3 and is released from the lock groove 310 of the door frame 300, thus realizing the unlocking of the storefront door 200.

Preferably, please refer to FIG. 2 to FIG. 6, the outdoor component 4 may be provided with a first matching slot 44 that is engageable with spindle 11, and the spindle 11 is inserted into the first matching slot 44, so as to facilitate the connection between spindle 11 and outdoor component 4, so as to facilitate the rotation of the spindle 11; The indoor component 5 can be provided with a second matching slot 55 that is engageable with the spindle 11, and the spindle 11 is connected with the second matching slot 55, so as to facilitate the connection between the spindle 11 and the indoor component 5 to facilitate the rotation of the spindle 11.

Preferably, please refer to FIG. 2 and FIG. 3, the indoor component 5 may further include a mounting plate 53 and a coupling element 54 connecting the second external force drive element 52 to the mounting plate 53. During installation, the fastening component 20 can be extended through the mounting plate 53 and the mortise 3, and then connected to the mounting plate 53 and the second external force drive element 52 through the coupling element 54, thus connecting the outdoor component 4, the indoor component 5 and the mortise 3.

Referring to FIG. 3, preferably, the surface of the mounting plate 53 adjacent to the mortise 3 may be provided with an abutment protrusion 531. During installation, the abutment protrusion 531 is engaged in a recess of the storefront door, to stably positioning the indoor component 5.

Preferably, please refer to FIG. 3. the mounting plate 53 may be provided with a fastening hole 532 to allow the insertion of fasteners such as screws into the mounting plate 53 to fix the abutment protrusion 53 to the mortise 3, thereby making the installation of the mounting plate 53 more firm.

Preferably, the surface of the mounting plate 53 adjacent to the indoor component 5 may be provided with a receiving groove 533 to accommodate a part of the second external drive member 52, thus effectively utilizing the space of the lock.

Preferably, in combination with FIGS. 1 to 3, the mounting plate 53 facing the mortise 3 may be provided with one or more connecting holes 534 to allow the mounting screw 22 to be inserted into the mounting plate 53 through the connecting hole 534 to be connected to the mounting post 21, or allow the mounting post 21 to be inserted into the fixing member 53 through the connecting hole 534 to be connected to the mounting screw 22, so as to connect the outdoor component 4, the mortise 3 and the indoor component 5 one another in the axial direction.

Referring to FIGS. 1 to 3, preferably, the second external force drive member 52 is connected to mounting plate 53 by the coupling element 54, which may be provided with a first installation through hole 541. the mounting plate 53 may be provided with one or more connecting walls 535, and the connecting walls 535 are provided with a second mounting through hole 5351 aligned with the first mounting through hole 541. Fasteners can be provided and inserted into the first installation through hole 541 and the second installation through hole 5351, so as to realize the connection of the second external force drive member 52 and the mounting plate 53, and the installation is easy and convenient. The fasteners may be screws or studs, etc., and the installation is firm and convenient.

It can be understood that the above is only one embodiment of the disclosure, the connection manner of the second external force drive member 52 and the mounting plate 53 is not limited to this, for example, the second external force drive member 52 and the mounting plate 53 can also be connected by snapping-fit, bonding elements or welding.

Further, the coupling element 54 can be formed as a ring, so that after the installation is completed, it can surround portions of the connecting walls 535 and the indoor component 5, so as to protect the portions of the connecting walls 535 and the indoor component 5.

Further, the first installation through hole 541 may penetrate through the coupling element 54 in a direction perpendicular to the length direction of the indoor component 5, that is, the direction from the periphery to the interior of the coupling element 54, so that the installation of the mounting plate 53 and the second external force drive member 52 can be directly achieved on the side of the coupling element 54, and the installation space is large and convenient for users. Further, the number of each of the first mounting through hole 541 and the second mounting through hole 5351 may be one, that reduces the cost. The number of the first mounting through holes 541 and the second mounting through holes 5351 may be more than one, so that the connection between the second external force drive member 52 and the mounting plate 53 is more stable.

Preferably, referring to FIGS. 1 to 5, the indoor component 5 may be provided with a position limit groove 542 at a side facing the first mounting through hole 541 and the second mounting through hole 5351. When the fastener is tightly inserted into the first installation through hole 541 and the second installation through hole 5351, the fastener abuts against the bottom of the position limit groove 542, and the side wall of the position limit groove 542 limits the position of the fastener, to avoid the fastener to tilt and scratch other parts of the indoor component 5 during installation.

### Second Embodiment

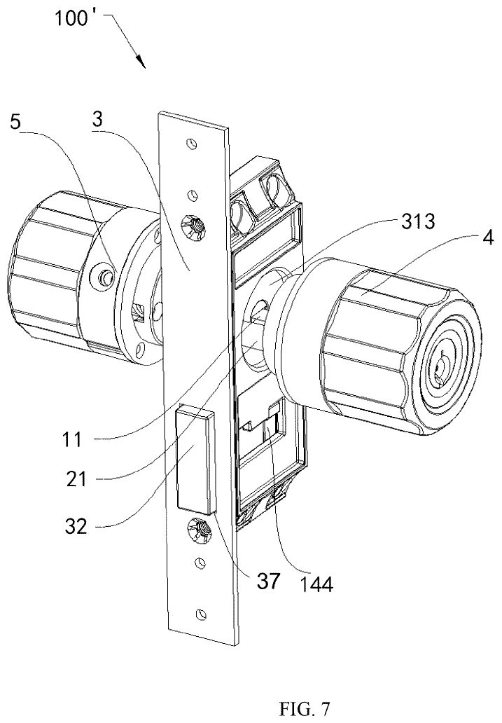

FIGS. 7 and 8 illustrate a second embodiment of a replacement lock for storefront door 100′ according to the present disclosure. This embodiment is similar to the first embodiment, and descriptions of the same components can be referred to the descriptions of the first embodiment and will not be repeated again. This embodiment differs from the first embodiment in that the drive structure for the lock bolt 32 is different.

In this embodiment, it does not use a lever to transmit the torque from the follower to the lock bolt. Instead, a receiving groove 322 is provided in the lock bolt 32, and a distal end of the drive protrusion 122 is received in the receiving groove 322 to drive the lock bolt 32 to slide. In the present embodiment, a slide block 144 is slidably arranged in the receiving groove 322, against which the distal end of the drive protrusion 122 of the follower 12 abuts. The slide block 144 can slide up and down (slide up refers to the direction from the lock bolt 32 to the follower 12, and slide down refers to the direction of the follower 12 to the lock bolt 32). An elastic component 1441 is provided in the receiving groove 322 abutting against the slide block 144. The elastic component 1441 provides an elastic force which biases the slide block 144 to move upwardly so as to always abut against the distal end of the drive protrusion of the follower 12.

Preferably, an upper surface of the slide block is a convex curved surface.

When the follower 12 rotates in the first direction, the distal end of the follower 12 frictionally slide over the upper surface of the slide block 144, and in the meanwhile drives the lock bolt 32 through the slide block 144 to move rightwards to lock the storefront door 200. At the same time, pressed by the distal end of the follower 12, the slide block 144 slides downwardly and then will be restored upwardly by the resilient force of the elastic component 1441 when the distal end of the follower 12 moves to a right side of the slide block 144 from the left side of the slide block 144, which allows a vertical displacement of the distal end of the follower 12 and in the meanwhile maintain the position of the follower 12. In addition, the movement of the slide block 144 provides a detent for the locking action.

When the follower 12 rotates in the second direction, the distal end of the follower 12 frictionally slide over the upper surface of the slide block 144, and in the meanwhile drives the lock bolt 32 through the slide block 144 to move leftwards to unlock the storefront door 200. At the same time, pressed by the distal end of the follower 12, the slide block 144 slides downwardly and then will be restored upwardly by the resilient force of the elastic component 1441 when the distal end of the follower 12 moves to the left side of the slide block 144 from the right side of the slide block 144, which allows a vertical displacement of the distal end of the follower 12 and in the meanwhile maintain the position of the follower 12.

Specifically, the elastic element 1441 may be, for example, a spring or an elastic pad.

Preferably, the surface of the follower 12 adjacent to the mortise 3 may be provided with a support web 124 which is rested on the shell of the mortise 3 and thus supporting the follower 12, thereby ensuring that the movement of the follower 12 is more stable.

Preferably, in combination with FIG. 2 and FIG. 7, the mortise 3 may be provided with a positioning groove 313 engageable with the abutment wall 42 at a side facing the abutment wall 42. During installation, the abutment wall 42 can be received into the installation positioning slot 313, so as to facilitate the installation and positioning of outdoor component 4.

Preferably, the mortise 3 may be also provided with a positioning groove 313 fit with the abutment protrusion 531 at a side facing the abutment protrusion. During installation, the abutment protrusion 531 can be received in the installation positioning slot 313, so as to facilitate the installation and positioning of indoor component 5.

### Third Embodiment

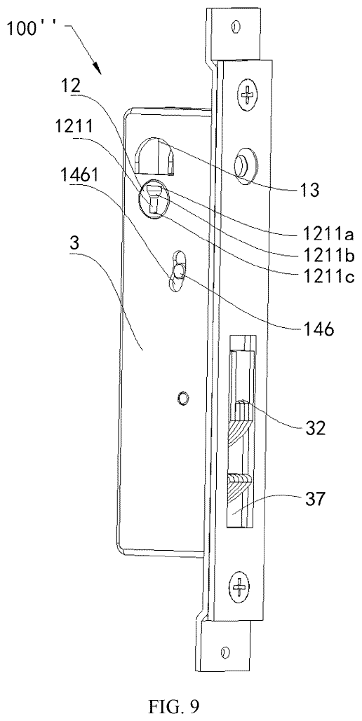

FIG. 9 and FIG. 10 illustrate a third embodiment of a replacement lock for storefront door 100″ according to the present disclosure. This embodiment is similar to the first embodiment, and descriptions of the same components can be referred to the descriptions of the first embodiment and will not be repeated again.

This embodiment differs from the first embodiment in the number of the mounting hole 13 of the mortise 3, and the different transmission manner between the follower 12 and the lock bolt 32.

In particular, the first embodiment provides two mounting holes 13 but in the present embodiment only one mounting hole 13 is provided. Accordingly, only one mounting screw 22 is required in this embodiment.

Further, in this embodiment, the cam hole 1211 of the sleeve 121 of the follower 12 may include a first portion 1211a, a second portion 1211b and a third portion 1211c connected one another. The second portion 1211b is located between the first portion 1211a and the third portion 1211c. The section of the first part 1211a is rectangular with a first width. The section of the third portion 1211c is rectangular with a second width smaller than the first width. The section of the second portion 1211b with a varying width that decreases from the first width to the second width. Such shape can well drive the rotation of the follower 12.

In the present embodiment, the follower 12 indirectly drives the lock bolt 32 through the torque transmission component 14 to extend out or retract back. In particular, the torque transmission component 14 may include a transmission plate 145, the middle part of the transmission plate 145 is rotatable connected to the mortise 3. The upper end of the transmission plate 145 adjacent to the follower 12 is provided with a groove 1451, into which the distal end of the follower 12 extends. The lower end of the transmission plate 145 away from the follower 12 is rotatably connected to the lock bolt 32. The lock bolt 32 is rotatably connected to the locking body 3. When the spindle 11 rotates in the first direction and drives the follower 12 to rotate, the rotating follower 12 in turn drives the upper end of the transmission plate 145 to move leftwards, the lower end of the transmission plate 145 to move rightwards, to drive one end of the lock bolt 32 away from the transmission plate 145 to extend out and lock the storefront door 200.

When the spindle 11 rotates in the second direction and drives the follower 12 to rotate in the second direction, the follower 12 drives the upper end of the transmission plate 145 to move rightwards, the lower end of the transmission plate 145 to move leftwards, and thus the end of the lock bolt 32 away from the transmission plate 145 is retracted back and unlocks the storefront door 200.

Preferably, the torque transmission component 14 also includes a limit shaft 146 arranged on the transmission plate 145, and the first shell 311 or the second shell 312 of the mortise 3 is provided with a limit hole 1461 engageable with the limit shaft 146. The limit shaft 146 is inserted in the limit hole 146, the boundary of the limit hole 1461 can limit the travel of the limit shaft 146, and thus the travel of the transmission plate 145. In this way, the displacements of the follower 12 is limited, to avoid the deviation of the follower 12 and impact on other parts.

The disclosure provides a replacement lock for storefront door 100, which includes an outdoor component 4, an indoor component 5, a mortise 3, a spindle torque transmission component 1 and a mounting component 2.

The outdoor component 4 is installed on the outside of the storefront door 200, and the outdoor component 4 includes a lock cylinder 41.

The indoor component 5 is installed on the inside of storefront door 200. The mortise 3 includes a housing 31 fixed in the storefront door 200, and a lock bolt 32 movable arranged in the housing 31. The lock bolt 32 can be extended out from or retracted back into the storefront door 200 to achieve lock or unlock when driven. The spindle torque transmission component 1 includes a spindle 11 with one axial end connected with the lock cylinder 41 of the outdoor component 4, and a follower 12 which is arranged in the housing 31 of mortise 3. The follower 12 is in torque-transmission connection with the lock bolt 32. The spindle 11 extends inwardly from the lock cylinder 41 of outdoor component 4 to the inner side of storefront door 200 through the locking body 3 and is connected with indoor component 5 at its other axial end. The spindle 11 is torque-transmission connected with the follower 12. Upon driven by an external force or a key, the spindle 11 can rotate in the first direction, driving the follower 12 to move and drive the lock bolt 32 to extend out of the housing 31 into the door frame and lock the storefront door 200; and can also rotate in the second direction, driving the follower 12 to move and drive the lock bolt 32 to retract back and unlock the storefront door 200. The mounting component 2 includes a fastening component 20. A middle section of the fastening component 20 passes through the mounting hole 13 on the housing 31 of the mortise 3, and the two ends of the fastening component 20 are fixed to the outdoor assembly 4 and the indoor assembly 5, respectively.

During installation, the mortise 3 can be fixed on the storefront door 200 first, and then the spindle 11 extends through the mortise 3 from the lock cylinder 41 of the outdoor component 4 and is connected to the indoor component 5, with the spindle 11 being torque-transmission connected with the follower 12. At the same time, the middle section of the fastening component passes through the mounting hole 13 on the housing 31 of the mortise 3, and the two ends of the fastening component are respectively fixed and connected with the outdoor component 4 and the indoor component 5, so that the outdoor component 4, the indoor component 5 and the mortise 3 can be connected one another in the axial direction and fixed on the storefront door 200 by the mounting component 2, and thus achieving the installation of the replacement lock for storefront door 100.

When in use, the spindle 11 can rotate in the first direction in response to an action caused by an external force or a key, or a signal, and the spindle 11 drives the follower 12 to move and drive the lock bolt 32 to extend out so as to lock the storefront door 200. The spindle 11 can also rotate in the second direction to drive the follower 12 to move and drive the lock bolt 32 to retract back so as to unlock the storefront door 200. Therefore, the lock according to the present invention can not only facilitate the installation and fixing of the indoor and outdoor components on both sides of the mortise 3 aligned with the spindle 11, but also reduce the installation difficulty and solve the problem in installing a replacement lock 100 for a storefront door. Moreover, it can realize the connection between indoor and outdoor components and the mortise 3, facilitating the coordination between indoor components 5 and outdoor components 4, and make it possible to lock and unlock with keyless lock or electronic lock with gear drive.

### Fourth Embodiment

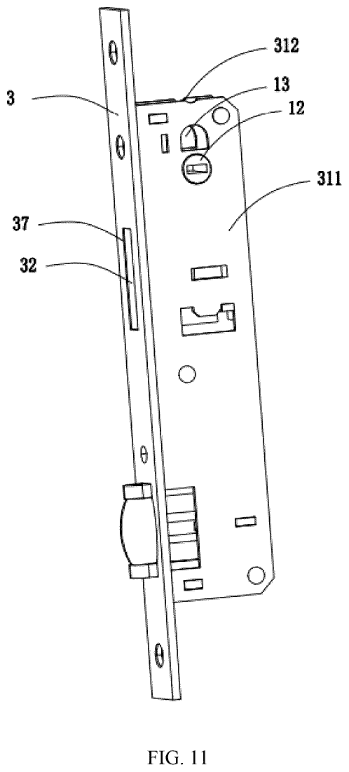

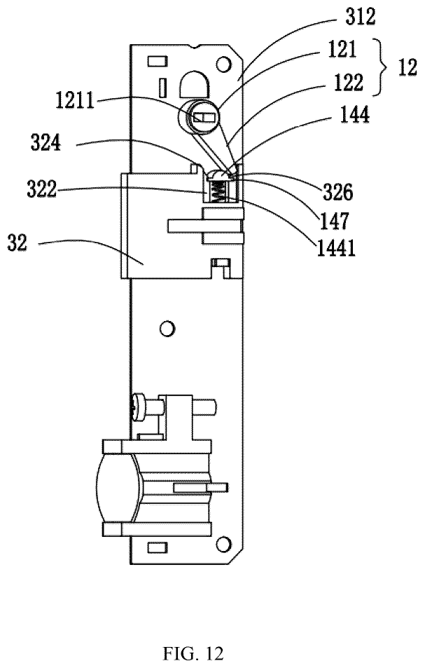

FIG. 11 and FIG. 12 illustrate a fourth embodiment of a replacement lock for storefront door 100 according to the present disclosure. This embodiment is similar to the second embodiment, and descriptions of the same components can be referred to the descriptions of the second embodiment and will not be repeated again.

This embodiment differs from the second embodiment in the number of the mounting hole 13 of the mortise 3, and the shape of the receiving groove 322.

In particular, the second embodiment provides two mounting holes 13 but in the present embodiment only one mounting hole 13 is provided. Accordingly, only one mounting screw 22 is required in this embodiment.

Further, in the second embodiment, the receiving groove 322 is U shaped with a substantially constant width. However, in the present embodiment, the receiving groove 322 has an enlarged open end, that is, the width of the receiving groove 322 at the upper end is larger than the width of the receiving groove 322 at the remaining portion. In particular, the surface 326 surrounding the upper end of the receiving groove 322 is inclined and the upper end of the receiving groove 322 is flared.

In the present embodiment, an engagement structure is provided to slidably position the slide block 144 relative to the lock bolt 32. In particular, the engagement structure includes a radial flange 147 formed on the slide block 144, which abuts against a peripheral surface of the lock bolt 32 beside the receiving groove 322. The radial flange 147 is received in a gap formed between an inner surface of the shell and the peripheral surface 326 of the lock bolt 32 such that the slide block 144 is guided during sliding without undesired displacement or deviation.

Further, in this embodiment, the support web of the follower 12 is omitted.

### Fifth Embodiment

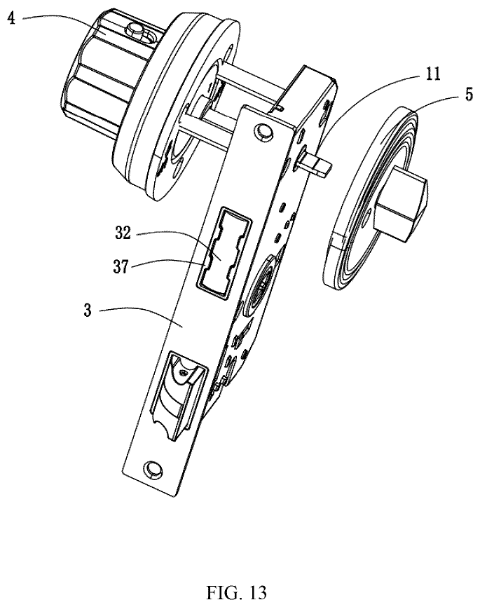

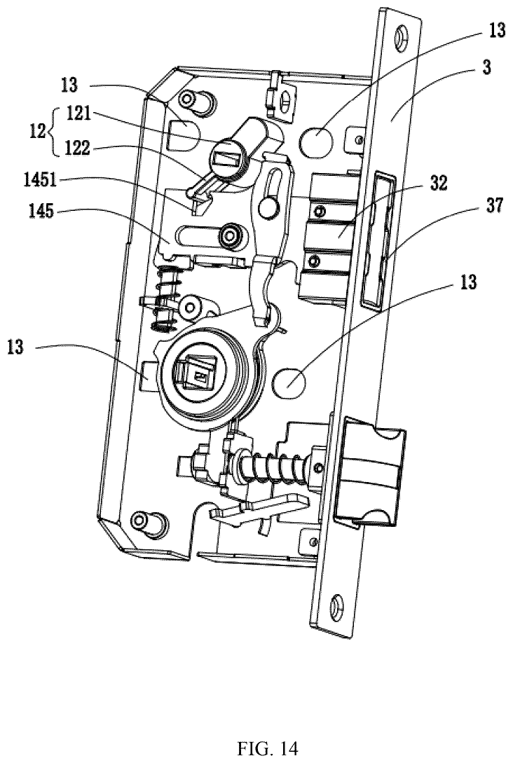

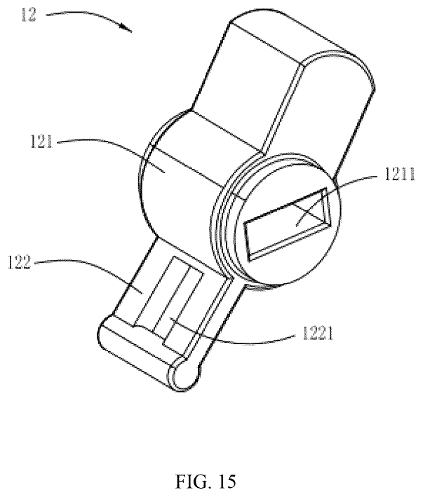

FIGS. 13 to 15 illustrate a fifth embodiment of a replacement lock for storefront door according to the present disclosure. This embodiment is similar to the third embodiment, descriptions of the same components can be referred to the descriptions of the second embodiment and will not be repeated again.

This embodiment differs from the second embodiment in the number of the mounting holes 13 of the mortise 3, the shape of the groove 1451 and the structure of the follower 12.

In particular, this embodiment provides four mounting holes 13, while in the third embodiment, only one mounting hole 13 is provided. Accordingly, the number of mounting screws is different accordingly.

In addition, in the third embodiment the groove 1451 is substantially U shaped, but in the present embodiment, there is a peg at the opening end of the groove 1451.

Further, in the third embodiment, the drive protrusion 122 is tapered as away from the sleeve 121, but in the present embodiment, the drive protrusion 122 is rectangular and hollow, with a hole 1221 defined in the central portion thereof. The peg is engaged with the hole 1221.

### Sixth Embodiment

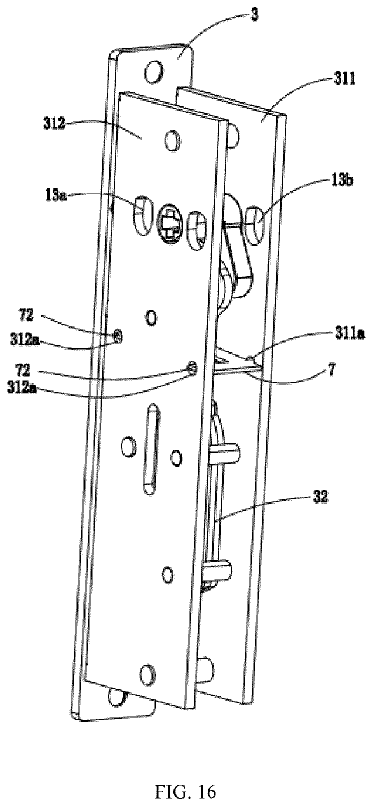

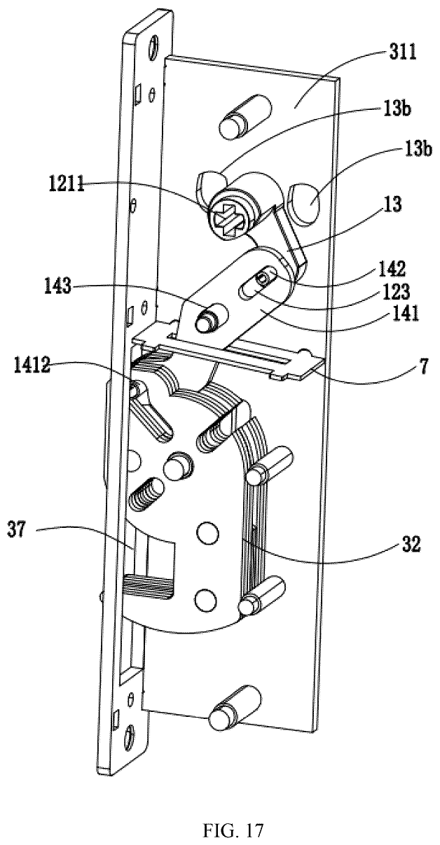

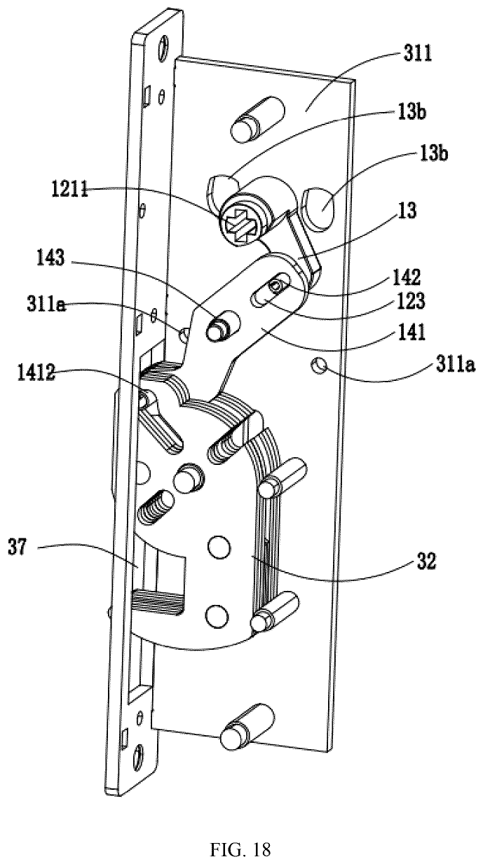

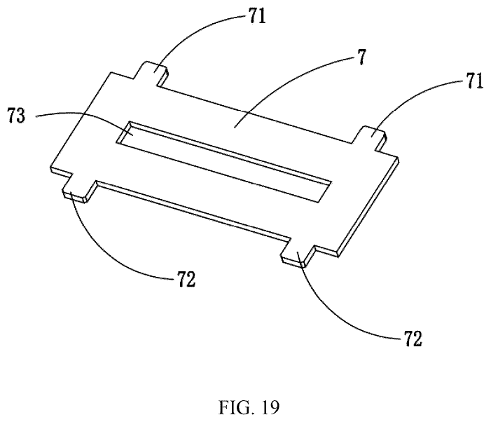

FIGS. 16 to 19 illustrate a sixth embodiment of a replacement lock for storefront door according to the present disclosure. This embodiment is similar to the first embodiment with using the follower and corresponding lever shown in FIG. 5a, and descriptions of the same or similar components can be referred to the descriptions of the first embodiment and will not be repeated again. This embodiment differs from the first embodiment in that a blocking member 7 is added in the replacement lock.

The blocking member 7 is arranged in and fixed to the housing 31 of the mortise 3. The blocking member 7 may have a plurality of protrusions 71, 71, and the housing 31 has a plurality of installation holes 311a, 312a respectively corresponding to the protrusions 71, 72 of the blocking member 7. In particular, in this embodiment, the first shell 311 has two first installation holes 311a, and the second shell 312 has two second installation holes 312a. Accordingly, the blocking member 7 has two first protrusions 71 at one side, and two second protrusions 72 at an opposed side. The first protrusions 71 are engaged with the first installation holes 311a, and the second protrusions 72 are engaged with the second installation holes 312a, to thereby fixedly install the blocking member 7 to the housing.

The blocking member 7 is located to block a path from the lateral opening 37 to the pin 142 of the follower 12, so as to prevent a bypass tool having a hook from extending into the housing 31 through the lateral opening 37 to the pin 142, hooking the pin 142 and pulling the pin 142 to move and drive the lock bolt 32 to retract back so as to unlock the door.

Specifically, the blocking member 7 is substantially in a plate form, with the first protrusions 71 and the second protrusions 72 are located at two opposite sides respectively. The blocking member 7 is arranged to traverse to the fist shell 311 and the second shell 312. The blocking member 7 further has a central hole 73 extending there through in a thickness direction of the blocking member 7. The lever 141 movably extends through the central hole 73 of the blocking member 7. As a result, the block member 7 does not interfere with the movement of the level 141 and thus the lock bolt 32, while increasing the security of the replacement lock. Due to the blocking member 7, the replacement lock provided by this embodiment has high reliability and security.

The above only discloses some of the embodiments of the present disclosure and does not intend to limit the invention. Any modification, equivalents or improvement made within the spirit and principle of the disclosure shall be included in the scope of protection of the invention.

1. A replacement lock for storefront door, configured to be installed in a storefront door so as to lock or unlock the storefront door relative to a door frame, the replacement lock comprising:
an outdoor component, configured to mounted at an outer side of the storefront door;
an indoor component, configured to be mounted at an inner side of the storefront door;
a mortise comprising:
a housing fixedly mounted in the storefront door, the housing having one or more mounting holes;
a lock bolt movably received in the housing, wherein the lock bolt is configured to, upon driven, extend out of the housing into a bore of the door frame to lock the storefront door, and retract from the bore of the door frame into the housing to unlock the storefront door;
a spindle torque transmission component comprising a spindle having opposed first and second axial ends, the spindle extending through the housing of the mortise and coupled with the lock bolt in a torque transmission way;
one or more mounting components, extending through the one or more mounting holes of the housing of the mortise respectively, the or each mounting component having two axial ends that are respectively fixedly connected to the outdoor component and the indoor component, and
a follower movably mounted in the housing of the mortise, the spindle being coupled to the lock bolt through the follower, and the follower comprising:
a sleeve having a cam hole engageable with the spindle, and the spindle extending through the cam hole; and
a drive protrusion extending from the sleeve to drive the lock bolt, the drive protrusion driving the lock bolt through a torque transmission component;
wherein when the spindle rotates, the spindle drives the follower to rotate, and the follower in turn drives the lock bolt to extend out or retract back, the torque transmission component comprises a lever, and one end of the lever is rotatable connected to the lock bolt, and wherein the drive protrusion and the lever are rotatable connected to each other through a pin and a groove that are engaged with each other, the spindle is drivable and rotatable upon an action or a signal from the outdoor component or the indoor component, and upon being driven the spindle drives the lock bolt to extend out or retract back.

2. The replacement lock for storefront door of claim 1, wherein the or each of mounting components comprises a mounting screw with one end fixed to the indoor component, and the mounting screw has a threaded shaft passing through a corresponding mounting hole and being connected to the outdoor component in threaded connection.

3. The replacement lock for storefront door of claim 2, wherein the or each of the mounting components further comprises a threaded mounting post with one end fixed to the outdoor component, and an other end of the mounting post is screwed with the threaded shaft of a corresponding mounting screw.

4. (canceled)

5. (canceled)

6. The replacement lock for storefront door of claim 1, wherein the drive protrusion extends from an outer periphery of the sleeve.

7. (canceled)

8. (canceled)

9. The replacement lock for storefront door of claim 1, wherein the pin is provided on the lever, and the groove is formed in the drive protrusion.

10. The replacement lock for storefront door of claim 1, wherein the pin is formed on the drive protrusion, and the groove is formed in the lever.

11. The replacement lock for storefront door of claim 10, wherein the groove is elongated with a length measured in an axial direction of the lever greater than a width measured in a lateral direction of the lever perpendicular to the axial direction.

12. The replacement lock for storefront door of claim 7, wherein the torque transmission component comprises a slide block, the lock bolt is provided with a receiving groove in which the slide block is slidable received, and a distal end of the drive protrusion abuts against an upper surface of the slide block.

13. The replacement lock for storefront door of claim 12, wherein the upper surface of the slide block is a convex curved surface.

14. The replacement lock for storefront door of claim 12, further comprising an elastic component provided in the receiving groove, and the elastic component abuts against a bottom of the slide block to bias the slide block upwardly.

15. The replacement lock for storefront door of claim 12, wherein an upper end of the receiving groove is flared and a surface surrounding the upper end of the receiving groove is inclined.

16. The replacement lock for storefront door of claim 7, wherein the torque transmission component comprises a torque transmission plate, one end of the torque transmission component is rotatably connected to the lock bolt, and an other end of the torque transmission component is provided with a groove into which a distal end of the drive protrusion of the follower extends.

17. The replacement lock for storefront door of claim 16, wherein the groove is U shaped; and
wherein the torque transmission plate has a peg at an opening end of the groove.

18. The replacement lock for storefront door of claim 1, wherein the outdoor component comprises a lock cylinder and an external force drive element both connected to the spindle; or
the outdoor component is coupled to an actuator connected to the spindle.

19. The replacement lock for storefront door of claim 1, wherein the indoor component comprises an external force drive element or is coupled to an actuator connected to the spindle.

20. The replacement lock for storefront door of claim 1, further comprising a blocking member fixed in the housing, wherein the housing of the mortise has a lateral opening through which the lock bolt extends out of the housing and retracts back into the housing, and the blocking member is arranged to block a path in the housing from the lateral opening to the follower.
